(19) United States
(12) Patent Application Publication
(10) Pub. No.: US 2020/0060089 A1
(43) Pub. Date: Feb. 27, 2020

(54) HIGH-POWER POWER SYSTEM AND LAWN MOWER

(71) Applicant: ZHEJIANG LERA NEW ENERGY POWER TECHNOLOGY CO., LTD., Ningbo City, Zhejiang Province (CN)

(72) Inventor: Bin LI, Ningbo City, Zhejiang Province (CN)

(21) Appl. No.: 16/611,819

(22) PCT Filed: Apr. 18, 2018
(86) PCT No.: PCT/CN2018/083597

§ 371 Date: Nov. 7, 2019

(30) Foreign Application Priority Data
May 10, 2017 (CN) 201710323546.4

(51) Int. Cl. A01D 69/02

(52) U.S. Cl. CPC A01D 69/02; A01D 2101/00

(57) ABSTRACT

A high-power power system has a shell, an internal control module, and at least one battery pack, wherein a control wire is led out of the control module and has a wiring terminal penetrating through the shell and serving as a connection terminal to be connected to an electrical device to realize control over the electric device, so that separated configuration of the electrical device and the power system is fulfilled; and the battery pack is mounted in the shell and is electrically connected to the control module. According to the high-power power system, a data cable used for connecting a control module of the electrical device with the control module of the power system is configured as two parts, so that the electrical device and the power system can be separately configured.

### BACKGROUND OF THE INVENTION

### Technical Field

The invention belongs to the technical field of machines, and relates to a power system, in particular to a high-power power system and a lawn mower.

### Description of Related Art

The power system is an important component of any electrical devices, just like the heart of humans. However, in existing electrical devices, a control part of the power system is integrally connected to a control system of the electrical device, namely, the power system cannot be independently disassembled from the electrical device, so that the power system is limited when in use. That is to say, the power system can only be applied to this electrical device, and cannot be transferred to other electrical devices, and consequentially, more types of power systems have to be fabricated, the universality of the power systems is reduced, industrialized management is unlikely to be fulfilled, and the power systems are inconvenient to maintain.

In conclusion, it is necessary to design a power system which can be separated from electrical devices and can be conveniently maintained later.

### BRIEF SUMMARY OF THE INVENTION

### Technical Solution

The objective of the invention is to solve the aforesaid problems of the prior art by providing a high-power power system which can be separated from an electrical device and can be conveniently maintained later.

The above-mentioned objective of the invention is fulfilled through the following technical solution: a high-power power system comprises a shell and an internal control module, wherein a control wire is led out of the control module and has a wiring terminal penetrating through the shell and serving as a connection terminal to be connected to an electrical device to realize control over the electrical device, so that separated configuration of the electrical device and the power system is fulfilled.

In the above-mentioned high-power power system, the wiring terminal of the control wire is exposed out of the shell and is sleeved with a sleeve.

In the above-mentioned high-power power system, the high-power power system further comprises at least one battery pack which is mounted in the shell and electrically connected to the control module.

In the above-mentioned high-power power system, the battery pack is connected with the shell in a buckling manner.

In the above-mentioned high-power power system, the battery pack is obliquely inserted into the shell.

In the above-mentioned high-power power system, the shell includes an upper shield, a housing, and a battery holder; and the upper shield, the housing and the battery holder are connected detachably.

In the above-mentioned high-power power system, at least one air inlet facing the ground is formed in the side wall of the housing.

In the above-mentioned high-power power system, the number of the air inlets is two, and the two air inlets are symmetrically distributed in two sides of the housing.

In the above-mentioned high-power power system, the high-power power system further comprises a brushless motor which is mounted in the shell and electrically connected to the control module.

In the above-mentioned high-power power system, the brushless motor and the battery pack are respectively located at two ends of the power system, wherein a plurality of air outlets are formed in an annular array manner in a side, close to the ground, of the brushless motor in the axial direction of the brushless motor and are in cooperation with the air inlets.

In the above-mentioned high-power power system, opening directions of the air outlets are parallel to the horizontal ground.

In the above-mentioned high-power power system, the high-power power system further comprises centrifugal fan blades arranged on the brushless motor.

In the above-mentioned high-power power system, the high-power power system further comprises a dustproof baffle which is located above the centrifugal fan blades and connected with the housing.

In the above-mentioned high-power power system, the high-power power system further comprises a security key which is inserted into the housing and connected with the control module.

A lawn mower comprises a body and the high-power power system detachably connected to the body, wherein the body is provided with a control system used for controlling operation of the lawn mower, and a control wire is led out of the control system and has a wiring terminal connected with the wiring terminal of the control wire in the power system.

In the above-mentioned lawn mower, the wiring terminal of the control wire located on the high-power power system is a female wiring terminal, the wiring terminal of the control system located on the body is a male wiring terminal, and the female wiring terminal is inserted connection with the male wiring terminal.

In the above-mentioned lawn mower, a sleeve is arranged on the male wiring terminal and is provided with a lock catch.

Compared with the prior art, the invention has the following beneficial effects:

(1) According to the high-power power system, a data cable used for connecting a control module of the electrical device with the control module of the power system is configured as two parts, that is to say, an original data cable is divided into two parts, wherein one part is connected to the control module of the electrical device, and the other part is connected to the control module of the power system, so that the electrical device and the power system are separately configured. Thus, the power system can be connected to different electrical devices, the application scope of the power system is widened, and the universality of the power system is improved. Besides, through the separated configuration of the power system and the electrical device, the power system is convenient to maintain later and is convenient to assembled and disassembled.

(2) According to the lawn mower, the independent high-power power system is arranged on the body of the lawn mower to fulfill the mowing action of the lawn mower, and the power system and the body are separately configured, so that the structural complexity of the body is lowered, and the body of the lawn mower is simple, light, and convenient to transport and move.

### BRIEF DESCRIPTION OF THE SEVERAL VIEWS OF THE DRAWINGS

FIG. 1 is a structural view of a high-power power system of the invention;

FIG. 2 is a sectional view of the high-power power system shown in FIG. 1;

FIG. 3 is an enlarged view of part A in FIG. 2;

FIG. 4 is an exploded view of the high-power power system of the invention;

FIG. 5 is an exploded view of a lawn mower of the invention.

### REFERENCE SIGNS

100, shell; 110, upper shield; 111, transparent window; 120, housing; 121, air inlet; 130, battery holder; 200, control module; 210, female wiring terminal; 300, battery pack; 400, brushless motor; 410, air outlet; 500; centrifugal fan blade; 600, dustproof baffle; 700, security key; 800, body; 810, male wiring terminal.

### DETAILED DESCRIPTION OF THE INVENTION

The technical solution of the invention is further expounded below in combination with the specific embodiments and the accompanying drawings, and the invention is not limited to the following embodiments.

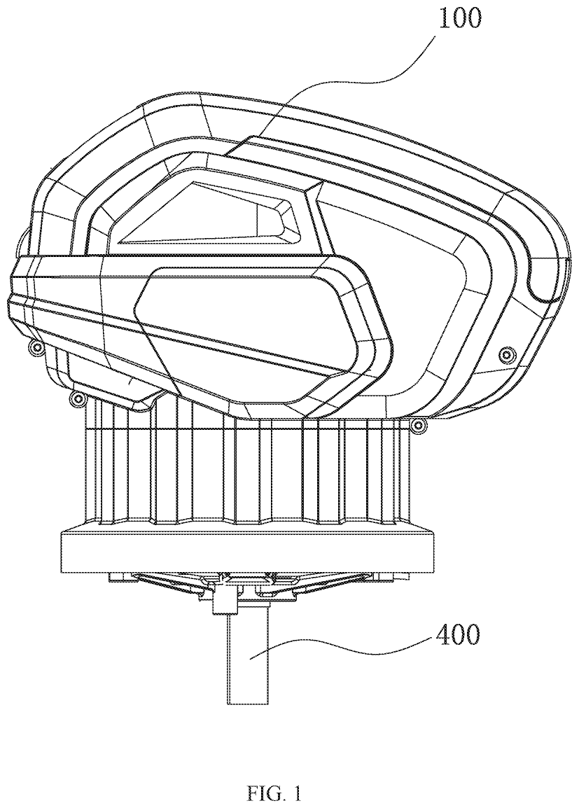

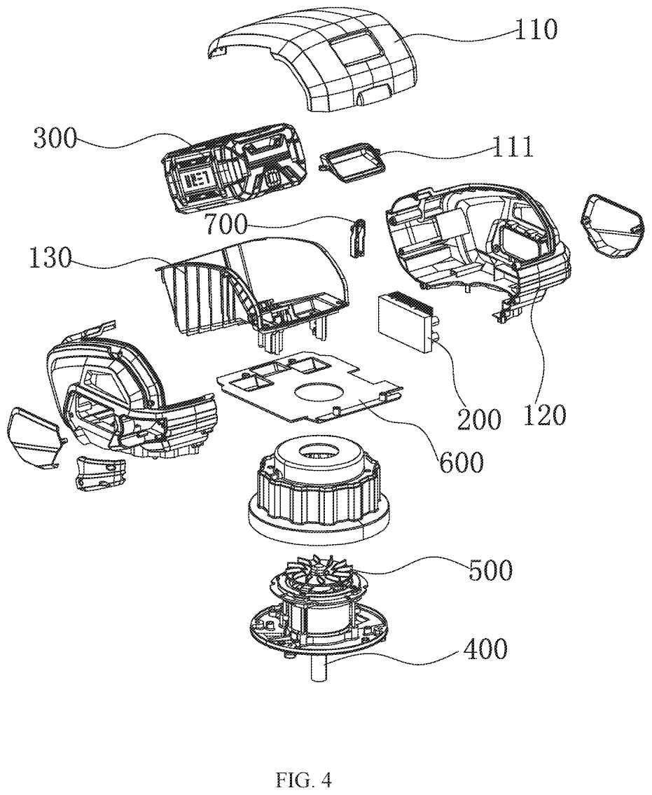

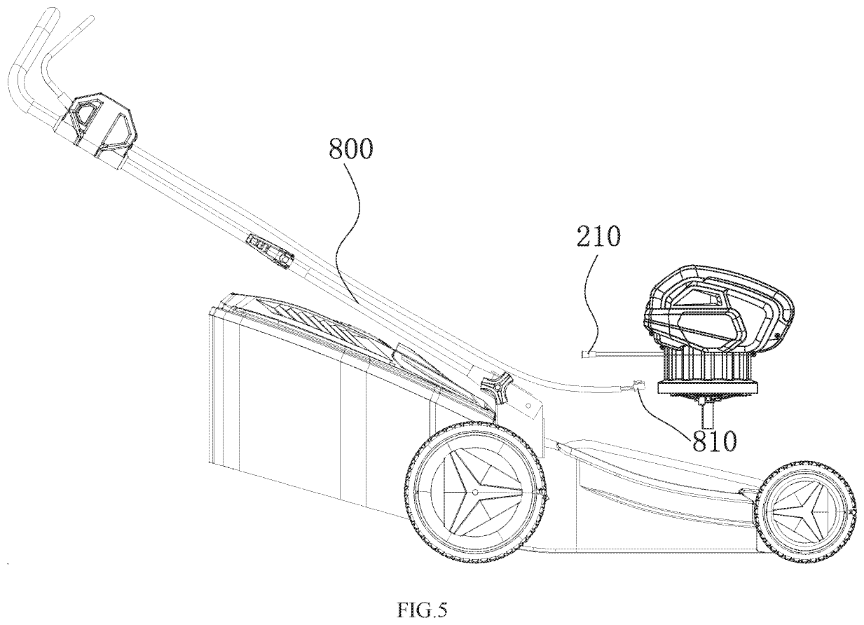

As shown in FIG. 1, FIG. 4, and FIG. 5, a high-power power system comprises a shell 100 and an internal control module 200, wherein a control wire is led out of the control module 200 and has a wiring terminal penetrating through the shell 100 and serving as a connection terminal to be connected to an electrical device to realize control over the electrical device, so that separated configuration of the electrical device and the power system is fulfilled.

According to the high-power power system, a data cable used for connecting a control module of the electrical device with the control module 200 of the power system is configured as two parts, that is to say, an original data cable is divided into two parts, wherein one part is connected to the control module of the electrical device, and the other part is connected to the control module 200 of the power system, so that the electrical device and the power system are separately configured. Thus, the power system can be connected to different electrical devices, the application scope of the power system is widened, and the universality of the power system is improved. Besides, through the separated configuration of the power system and the electrical device, the power system is convenient to maintain later and is convenient to assemble and disassemble.

Further preferably, as shown in FIG. 1, FIG. 4, and FIG. 5, the wiring terminal of the control wire is exposed out of the shell 100 and is sleeved with a sleeve to prevent the control wire from retreating into the shell 100 during retraction, so that the reliability of the power system is improved. Besides, the shell is configured to protect the wiring terminal of the control wire against damage, so that the reliability of signal transmission is improved when the control module 200 of the power system and the control module of the electrical device are connected.

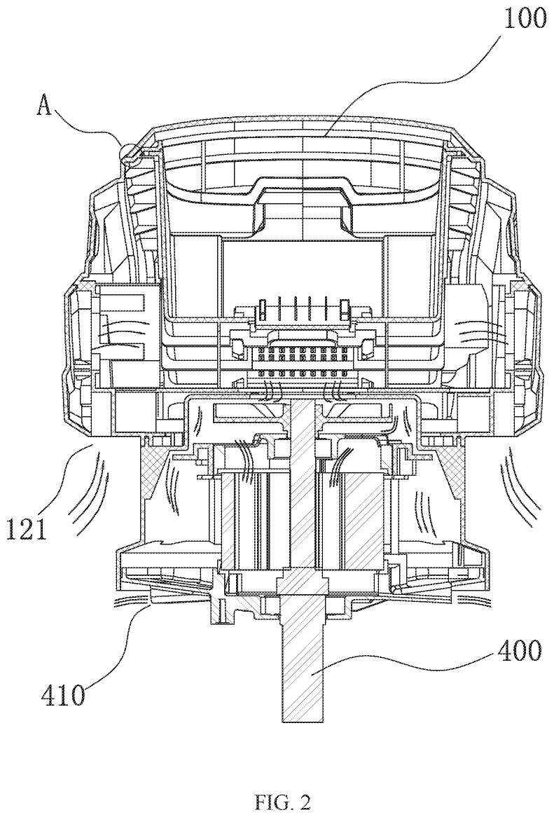

Preferably, as shown in FIG. 2 and FIG. 4, the high-power power system further comprises at least one battery pack 300 which is mounted in the shell 100 and electrically connected to the control module 200, wherein through the battery pack used as a power supply of the electrical device, the power system can serve as an independent system having both a power function and a control function, can exist independently, and can be connected to the electrical device or other electrical devices, so that the application value of the power system is increased.

Further preferably, as shown in FIG. 2 and FIG. 4, the battery pack 300 is connected with the shell 100 in a buckling manner, thus being convenient to assemble and disassemble. Preferably, the battery pack 300 is obliquely inserted into the shell 100. In this embodiment, the battery pack 300 is obliquely inserted so that users can check the power in the battery pack 300 more quickly through a power indicator light which is arranged on the battery pack 300 and used for observing the power in the battery pack 300, and compared with a horizontally-inserted connection manner, the oblique insertion of the battery pack 300 allows the users to check the power in the battery pack 300 more conveniently.

Further preferably, as shown in FIG. 2 and FIG. 4, the shell 100 includes an upper shield 110, a housing 120, and a battery holder 130 which are connected detachably, so that the shell 100 is of an enclosed structure to prevent external particles or macromolecular substances from entering the shell 100, which may otherwise affect the service life of the power system and make the power system more difficult to clean. Preferably, the upper shield 110 is transparent and is provided with a transparent window 111 used for real-time observation of the power in the battery pack 300.

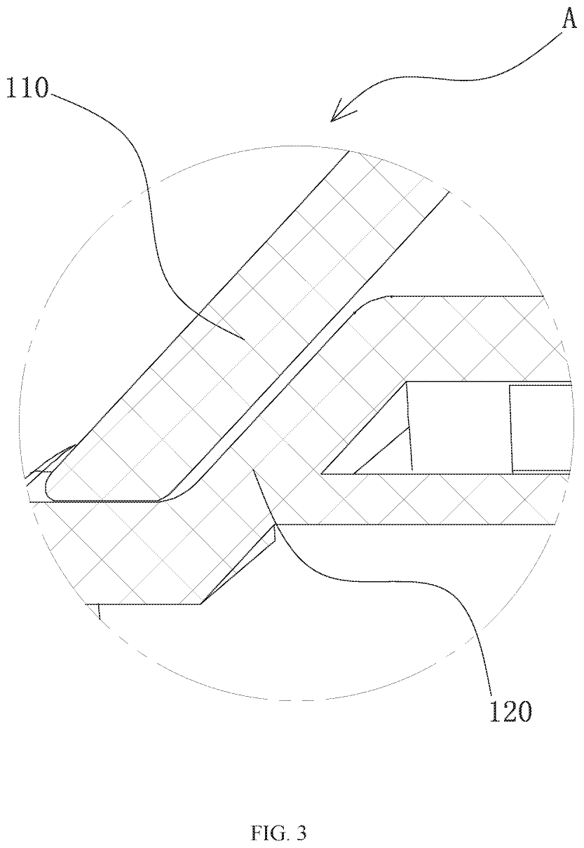

Further preferably, as shown in FIG. 2 and FIG. 3, the end face of the housing 120 is of a Z-shaped structure, the end face of the upper shield 110 is in wedged fit with the end face of the housing 120, and the end face of the housing 120 is higher than the end face of the upper shield 110 to prevent external water vapors from entering the housing, which may otherwise affect the circuit security and service life of the power system.

Further preferably, as shown in FIG. 2 and FIG. 4, at least one air inlet 121 facing the ground is formed in the side wall of the housing 120, the content of cold air is increased towards the ground because the specific gravity of hot air is less than that of cold air, and the cold air can enter the air inlet 121 more easily via the downward air inlet 121, so that the temperature of the control module 200 during operation is decreased, the control module 200 is kept at an appropriate operating temperature all the time, and the service life of the control module 200 is prolonged. Further preferably, the number of the air inlets 121 is two, and the two air inlets 121 are symmetrically distributed in two sides of the housing 120 to increase the quantity of air entering the housing 120, so that heat generated by the control module 200 during the operation can be taken away more rapidly.

Preferably, as shown in FIG. 2 and FIG. 4, the high-power power system further comprises a brushless motor 400 which is mounted in the shell 100 and electrically connected to the control module 200. When the brushless motor 400, serving as a power source of the electrical device, operates, a negative pressure will be generated at an operating part of the brushless motor 400, so that external air can enter the power system at a higher speed, namely the quantity of air entering the power system is increased. Because inlet air is delivered from bottom to top, air supply circulation systems are formed on two sides of the power system to fulfill a better cooling effect on the power system. Further preferably, the brushless motor 400 and the battery pack 300 are respectively located at two ends of the power system, wherein a plurality of air outlets 410 are formed in an annular array manner in a side, close to the ground, of the brushless motor 400 in the axial direction of the brushless motor 400 and are in cooperation with the air inlets 121 to form a circulation channel of natural wind. Further preferably, slots are formed in the battery holder 130 and the battery pack 300, and the natural wind flows through the control module 200, the battery pack 300, the battery holder 130, and the brushless motor 400 after entering the shell 100 via the air inlets 121 and is discharged out of the air outlets 410 to take away all the heat generated by the control module 200 during operation, so that the power system is kept at an appropriate operating temperature all the time, and the service life of the power system is prolonged.

Further preferably, as shown in FIG. 2 and FIG. 4, the opening directions of the air outlets 410 are parallel to the horizontal ground, so that hot air discharged out of the air outlets 410 does not face the ground; if the power system is installed on a lawn mower, weeds mowed by the lawn mower in operation can be blown towards two sides to be prevented from entering the power system, so that the reliability of the power system is improved, intermittent removal of the weeds in the lawn mower is not needed, and the working efficiency of the lawn mower is effectively improved. In addition, cold air near the air outlets 410 can be blown by the hot air discharged out of the air outlets 410 away from the ground to move towards the air inlets 121, so that the circulation channel is further formed, and the quantity of air entering the air inlets 121 is further increased, and heat dissipation is accelerated.

Preferably, as shown in FIG. 2 and FIG. 4, the high-power power system further comprises centrifugal fan blades 500 which are arranged on the brushless motor 400 and are driven by the brushless motor 400 to rotate to increase the quantity of air entering the housing 120, so that heat dissipation is accelerated.

Preferably, as shown in FIG. 2 and FIG. 4, the high-power power system further comprises a dustproof baffle 600 which is located above the centrifugal fan blades 500 and is connected with the housing 120 to effectively prevent the macromolecular particles entering the housing 120 from reaching the brushless motor 400, which may otherwise affect the service life of the brushless motor 400.

Preferably, as shown in FIG. 1 and FIG. 2, at least one accommodating space is formed in the side wall of the housing 120 to be used as an installation position of the control module 200, external natural wind flows through the control module 200 after entering the shell 100 through the air inlets 121 to take away the heat generated by the control module 200, so that the control module 200 is kept at the appropriate operating temperature all the time, and the service life of the control module 200 is prolonged. Further preferably, the number of accommodating spaces is two, and the two accommodating spaces are respectively formed in two sides of the housing 120 and are used as installation positions of the control module 200.

Preferably, as shown in FIG. 1 and FIG. 2, the high-power power system further comprises a security key 700 which is inserted into the housing 120 and connected with the control module 200. When the power system is installed on the electrical device, the electrical device can normally work only if the security key 700 and a switch on the electrical device are simultaneously started, so that the security of the electrical device in use is improved.

As shown in FIG. 5, a lawn mower comprises a body 800 and a high-power power system detachably connected to the body 800, wherein the body 800 is provided with a control system used for controlling operation of the lawn mower, and a control wire is led out of the control system and has a wiring terminal connected to the wiring terminal of a control wire in the high-power power system, so that the power system supplies power to the body 800.

According to the lawn mower, the independent high-power power system is arranged on the body 800 of the lawn mower to fulfill the mowing action of the lawn mower, and the power system and the body 800 are separately configured, so that the structural complexity of the body 800 is lowered, and the body 800 of the lawn mower is simple, light, and convenient to transport and move.

Further preferably, as shown in FIG. 5, the wiring terminal of the control wire located on the high-power power system is a female wiring terminal 210, the wiring terminal of the control system located on the body 800 is a male wiring terminal 810, and the female wiring terminal 210 is in inserted connection with the male wiring terminal 810, so that a signal output by the high-power power system can be rapidly and reliably transmitted to the control system of the body 800. Thus, the reliability of the lawn mower is improved. Besides, by adoption of the inserted connection, the female wiring terminal 210 and the male wiring terminal 810 can be connected, assembled and disassembled more conveniently.

Further preferably, as shown in FIG. 5, a sleeve is arranged on the male wiring terminal 810 and is provided with a lock catch. The female wiring terminal 210 and the male wiring terminal 810 are kept in inserted connection through the lock catch, so that the male wiring terminal 810 and the female wiring terminal 210 will not be separated when the lawn mower operates on an uneven ground, thus improving the reliability and security of the lawn mower.

The specific embodiments described herein are only used for illustratively explaining the spirit of the invention. Various modifications, supplements, or similar substitutions of these specific embodiments can be made by those skilled in the art without deviating from the spirit of the invention and the scope defined by the appended claims of the invention.

What is claimed is:

1. A high-power power system, comprising:
a shell;
an internal control module; wherein a control wire is led out of the control module and has a wiring terminal penetrating through the shell and serving as a connection terminal to be connected to an electrical device to realize control over the electrical device, so that separated configuration of the electrical device and the power system is fulfilled; and,
at least one battery pack, the battery pack is mounted in the shell and is electrically connected to the control module.

2. The high-power power system according to claim 1, wherein the shell includes an upper shield, a housing, and a battery holder; and the upper shield, the housing and the battery holder are connected detachably.

3. The high-power power system according to claim 2, wherein at least one air inlet facing a ground is formed in a side wall of the housing.

4. The high-power power system according to claim 1, wherein the high-power power system further comprises a brushless motor which is mounted in the shell and electrically connected to the control module.

5. The high-power power system according to claim 4, wherein a plurality of air outlets are formed in an axial direction of the brushless motor.

6. The high-power power system according to claim 5, wherein opening directions of the air outlets are parallel to a horizontal ground.

7. The high-power power system according to claim 4, wherein the high-power power system further comprises centrifugal fan blades arranged on the brushless motor.

8. The high-power power system according to claim 7, wherein the high-power power system further comprises a dustproof baffle which is located above the centrifugal fan blades and connected with the shell.

9. The high-power power system according to claim 2, wherein an end face of the housing is higher than an end face of the upper shield to prevent external water vapors from entering the housing.

10. A lawn mower, comprising the high-power power system according to claim 1 and a body detachably connected to the power system, wherein the body is provided with a control system used for controlling operation of the lawn mower, and a control wire is led out of the control system and has a wiring terminal connected to the wiring terminal of the control wire in the power system.
